(19) United States
(12) Patent Application Publication
(10) Pub. No.: US 2026/0146927 A1
(43) Pub. Date: May 28, 2026

(54) DEVICE FOR IRRADIATING A SAMPLE AND USE OF A DEVICE FOR IRRADIATING A SAMPLE

(71) Applicant: opto biolabs GmbH, Freiburg im Breisgau (DE)

(72) Inventors: Kathrin BRENKER, Freiburg (DE); Luis Wolf Viktor KÖBELE, Kenzingen (DE)

(73) Assignee: opto biolabs GmbH, Freiburg im Breisgau (DE)

(21) Appl. No.: 19/399,962

(22) Filed: Nov. 25, 2025

(30) Foreign Application Priority Data
Nov. 27, 2024 (DE) 102024135031.8

(51) Int. Cl. G01N 1/44

(52) U.S. Cl. CPC G01N 1/44

(57) ABSTRACT

A device (1) for irradiating a sample using optical radiation, the device (1) including a sample container receptacle (3) for a sample container having at least two cavities, wherein a separate irradiation area (3) of the device (1) is assigned or assignable to each cavity of a sample container in the state positioned on the device (1), so that the device (1) includes as many separate irradiation areas (3) as a sample container has cavities. The device further includes control electronics unit (4). The irradiation areas (3) each have at least four irradiation units (5), and the emittable spectral ranges of the at least four irradiation units (5) differ.

### CROSS-REFERENCE TO RELATED APPLICATIONS

This application claims priority from German Patent Application No. 10 2024 135 031.8, filed Nov. 27, 2024, which is incorporated herein by reference as if fully set forth.

### TECHNICAL FIELD

The invention relates to a device for irradiating a sample using electromagnetic radiation, in particular using optical radiation, the device comprising a sample container receptacle for a sample container having at least two cavities, wherein each cavity (also referred to as a well) of a sample container is assigned or assignable a separate irradiation area of the device in the state positioned on the device, so that the device includes at least two separate irradiation areas. The sample container receptacle can be designed, for example, as a microtitration plate receptacle. Furthermore, the device comprises a control electronics unit. A device of the type mentioned at the outset can also be referred to as an illuminator.

### BACKGROUND

Devices of the type mentioned at the outset are already known and are used to treat samples, such as biological and/or chemical samples in particular, using electromagnetic radiation of a specific spectral range. Various methods and technologies exist in the field of life sciences for how light-sensitive molecules can be used to induce deliberate changes or effects in a sample (for example, optogenetics, photopharmacology).

To be able to emit a radiation dose, preferably such as an optical radiation dose (also referred to as a light dose), in controlled amounts, specialized devices such as the device of the type mentioned at the outset are necessary. In chemical and/or biological experiments, for example, when working with a cell culture, microtitration plates are often used as sample containers, in particular also so-called 24-well and 96-well plates, in which a cell sample is stored.

Various solutions currently exist for the irradiation of the samples which enable each of the wells or the sample contained therein to be addressed individually and to be irradiated using at least one wavelength.

However, it has been shown that previously known devices for irradiating a sample are not sufficient to address more complex approaches for carrying out experiments.

### SUMMARY

The object therefore exists of improving the usage properties of devices of the type mentioned at the outset.

This object is achieved according to the invention by the device having one or more of the features disclosed herein.

In particular, a device of the type mentioned at the outset is proposed according to the invention to achieve the object, which is characterized in that the irradiation areas each comprise at least four irradiation units, wherein the emittable spectral ranges of the at least four irradiation units differ. This has the advantage that a sample can be treated using at least four different spectral ranges, which is not possible using previous devices. More complex experiments can therefore be designed, for example, in order to deliberately influence a chemical reaction and/or a cellular activity by excitation using radiation in a specific wavelength. Thus, for example, optogenetic proteins, which were possibly formed by the expression of foreign genes implanted in target cells, can be modified by means of electromagnetic radiation.

The electromagnetic radiation can be, for example, optical radiation, thus comprising the ranges of ultraviolet radiation (UV), light visible to humans (VIS), and infrared radiation (IR). It is preferably light visible to humans in this case. In the case of light in the spectral range visible to humans, the irradiation can therefore be carried out by irradiation units which emit light of different colors. The number of the irradiation areas can be adapted to the number of the cavities of the sample container provided for the irradiation.

The term spectral range can relate to a specific frequency range and/or wavelength range of electromagnetic radiation. The spectral range can include a single peak point (also referred to as a peak), as well as peripheral areas leveling off therefrom. The spectral range can therefore be defined by its peak point, for example, by a wavelength and/or frequency present there. It can be provided that a full width at half maximum (abbreviated FWHM) of the spectral range is in the range of 10 to 40 nm. It can be provided that the different spectral ranges of the at least four irradiation units of an irradiation area overlap or do not overlap. In particular, the spectral ranges of the at least four irradiation units of an irradiation area can differ due to different peak points, for example, due to a different wavelength of the peak point.

Advantageous designs of the solution according to the invention are described hereinafter. These can be combined with the features noted above or herein to refine the invention.

According to one advantageous design, an irradiation intensity and/or irradiation duration for each irradiation unit can be individually controllable by the control electronics unit. Since the reaction to the irradiation is dose-dependent, wherein the radiation dose is in turn dependent on the parameters of the irradiation intensity and the irradiation duration, it is important to be able to control it precisely.

According to a further advantageous design, an irradiation intensity and/or irradiation duration for each irradiation area can be controllable independently of the at least one further irradiation area by the control electronics unit. It is therefore possible to treat samples contained in separate cavities of the sample container differently. It is therefore more easily possible to carry out more complex experiments by means of the device, since different irradiations with respect to the irradiation areas are possible at the same time.

To be able to handle more complex experimental sequences better by means of the device, a sequence protocol for the control, in particular for the automated control, of an irradiation intensity and/or irradiation duration for irradiating a sample by means of an irradiation area can be executable by the control electronics unit. The sequence protocol can control in this case which irradiation units in an irradiation area are activated for a specific duration. The control electronics unit preferably comprises a memory for storing the sequence protocol. For example, an activation of individual irradiation units of an irradiation area in succession can be controlled by the sequence protocol, preferably wherein only one irradiation unit per irradiation area is always activated.

It has been shown that control electronics units are previously known devices for irradiating a sample using electromagnetic radiation are not capable of being able to control a plurality of irradiation units per irradiation area. Thus, control electronics units of existing devices previously known from the prior art for sample irradiation in particular are not arbitrarily scalable and are therefore unsuitable for being able to control four or more irradiation units per irradiation area having different spectral ranges. It is therefore advantageous to provide a novel actuation concept which enables multiple irradiation units per irradiation area to be controlled more easily. To be able to achieve this better, the control electronics unit can be designed so that each irradiation unit is controllable or controlled via two switching devices of the control electronics unit. In particular, it is necessary here for both switching devices to permit a current flow for an activation of the respective irradiation unit.

According to an advantageous refinement, a first switching device of a first type can be designed as a switch and/or a second switching device of a second type can be designed as a current sink. The switching device of the first type assigned to one irradiation unit can be applied to an anode side of the irradiation unit. The switching device of the second type assigned to an irradiation unit can be applied to a cathode side of the irradiation unit. Preferably, the current sink can comprise at least one transistor, such as a metal-oxide semiconductor field-effect transistor (MOSFET). It is controllable by the two switching devices of the first and second type whether a current flow is possible through the assigned irradiation unit. A switching device of the first type has at least two switch positions or precisely two switch positions, wherein a first switch position corresponds to an open position, in which current flow is not possible, and a second switch position corresponds to a closed position, in which a current flow is possible. A switching device of the second type additionally also permits a setting of a specific, thus in particular a desired amperage. The switching device of the second type can be a micro-electrical circuit. It can thus be, for example, a current sink having transistor, operational amplifier, and measurement resistor. Furthermore, it can be an integrated circuit.

According to one design, each irradiation unit can comprise at least one light-emitting diode (abbreviated LED). Light-emitting diodes have the advantage that they generally consume very little energy and have a long service life. Especially for the device according to the invention, they have the advantage that they have a low heat development. This is advantageous, since undesired heat development can damage a sample. Light-emitting diodes differ significantly from other light sources with respect to the spectral range. They have a high level of flexibility and can be produced in various spectral ranges, for example, color temperatures. The spectral range can exclusively have one peak point (peak). It is therefore better possible to prevent secondary radiation having an undesired wavelength from occurring in addition to a desired wavelength range, in order to irradiate a sample therewith, which could negatively affect an experimental result.

According to one advantageous refinement, the control electronics unit can comprise at least one LED driver. It can preferably comprise at least one matrix LED driver. An LED driver or above all a matrix LED driver has the advantage over other known LED actuation methods that a significantly reduced number of connections is required. Fewer contacts and conductor tracks are thus required, which reduces the wiring expenditure. This moreover saves installation space and can contribute to keeping a heat development lower. In particular in devices for irradiating a sample, it is often desirable to keep the installation space as small as possible. Devices of this type are often used in laboratories and/or incubators, in which little space is present which can be provided for such a device. It is therefore desirable not to increase the space requirement in relation to previously known devices of the type mentioned at the outset. This can be achieved better by the use of an LED driver or also a matrix LED driver. Moreover, a matrix structure permits simple scalability, in order to also be able to use more than four irradiation units per irradiation area.

According to one advantageous refinement, the control electronics unit can comprise at least one multiplexer and/or enable multiplex operation, so that multiple switching devices and/or irradiation units are sequentially activatable via this. It can thus be necessary, for example, for the above-mentioned LED drivers to be used together with a multiplexer, the control electronics unit therefore comprises both components.

According to one design, the control electronics unit can be designed and/or set so that at most two irradiation units are activatable at the same time in one irradiation area. Preferably, only one irradiation unit can always be activatable per irradiation area. A multiplexer is an electronic component which merges multiple input signals to form a single output signal. A multiplexer can therefore have multiple switch positions, wherein current can only flow between input and output with a closed circuit. A multiplexer can therefore take over the task of one or more switches and/or current sinks.

According to one design, the irradiation areas can each comprise at least six, preferably eight, irradiation units, wherein radiation is emittable in a different spectral range by each of the irradiation units. Even greater flexibility and variety can therefore be achieved in carrying out experiments by means of a sample.

According to one design, the sample container receptacle can be designed to receive a microtitration plate. In this case, this can be, for example, at least a 24-well plate and/or a 96-well plate and/or a 384-well plate and/or a 1536-well plate. An irradiation area separate from other irradiation areas can be assigned to each well in the state of the microtitration plate positioned on the device. It can therefore be ensured better that each well is deliberately treated using only specific radiation.

According to an advantageous refinement, a switching device of the second type can be connected to twice as many irradiation units as a switching device of the first type. It is therefore possible to significantly reduce the wiring expenditure in the architecture of the control electronics unit.

Furthermore, it can be provided according to an advantageous design that a circuit of the control electronics unit is constructed according to the following pattern: number of irradiation units per irradiation area=number of switching devices of the first type×(times) number of switching devices of the second type. A particularly efficient design is therefore achievable. In particular, this calculation can be restricted to whole numbers.

According to a further advantageous design, the control electronics unit can use six switching devices for the control of each irradiation area. In particular, four of these can be designed as switching devices of the first type and two as switching devices of the second type. The wiring expenditure in the design of the control electronics unit can therefore be reduced further in relation to previously known actuation concepts.

To make as many switching states as possible implementable by means of as few switching devices as possible, the control electronics unit can be designed so that each switching device of the first type is connected to two irradiation units and each switching device of the second type is connected to four irradiation units.

To be able to achieve the most optimum possible irradiation of a cavity, the irradiation units of an irradiation area can be arranged so that at least two irradiation units always have an identical orientation. The most homogeneous possible irradiation of the sections of an irradiation area can thus be achieved. The term orientation can relate to an arrangement on a carrier, such as a printed circuit board in particular. Two irradiation units can thus always be arranged at an equal angle.

According to one design, the control electronics unit can comprise at least one microcontroller (microcontroller unit, abbreviated MCU), by means of which the switching devices are controllable. The microcontroller can preferably be connected via a data line, such as a serial data line, and/or a clock line, such as a serial clock line, to at least one or the LED driver. The wiring expenditure can thus be reduced further. The microcontroller can include one or more processor cores (CPUs), an integrated working memory (RAM), a program memory (such as a flash memory or ROM). The term microcontroller can be understood according to one design in particular as a single board computer, such as Raspberry Pi.

According to one design, at least two irradiation areas can be assigned to one LED driver, in particular a matrix LED driver. In particular, four switching devices of the first type, preferably four switching devices designed as switches, can each be connected to the first irradiation area and to the second irradiation area, and wherein the first irradiation area is connected to two switching devices of the second type and the second irradiation area is connected to two switching devices of the second type separate therefrom. The wiring expenditure can therefore be reduced further.

According to one design, the control electronics unit can comprise at least four, in particular at least six LED drivers, preferably at least twelve LED drivers, preferably such as matrix LED drivers, which are controllable via a single microcontroller, wherein a data line and/or a clock line is formed between the microcontroller and a first LED driver, wherein a further data line and/or a further clock line is formed between the first LED driver and the next LED driver. Preferably, this can be a serial data line and/or a serial clock line in this case. In particular, the data line and/or a clock line can be formed in each case between adjacent LED drivers. The wiring expenditure can thus be reduced further.

In order to be able to achieve the most space-saving, compact design possible, the control electronics unit and the irradiation areas can be formed on a common printed circuit board. However, it can be advantageous if the control electronics unit and the irradiation areas with the exception of a microcontroller are formed on a common printed circuit board and the microcontroller is formed on a microcontroller printed circuit board independent thereof. A particularly long-lasting design can therefore be achieved, since in case of a defect of the microcontroller, a complete replacement of a complex printed circuit board does not have to occur, but rather in this case only a new microcontroller printed circuit board is required as a replacement. This therefore saves resources and significantly reduces the repair costs.

According to a further design, an irradiation area can be connected to at least one multiplexer. In particular, an irradiation area can be connected to at least two multiplexers. In this case, a first multiplexer of the two can preferably be connected to a first switching device of the second type of an LED driver and a second multiplexer of the two can be connected to a second switching device of the second type of an LED driver. The wiring expenditure can thus be reduced further.

According to one design, a microcontroller of the control electronics unit can be connected via at least one data line and/or at least one clock line to at least one or the at least one multiplexer. A control of the multiplexer by the microcontroller is therefore possible.

The invention moreover relates to the use of a device as described and/or claimed herein for carrying out an irradiation of a sample, in particular a chemical and/or a biological sample.

### BRIEF DESCRIPTION OF THE DRAWINGS

The invention will now be described in more detail on the basis of several exemplary embodiments, but is not restricted to these exemplary embodiments. Further exemplary embodiments result from the combination of the features of individual or multiple claims with one another and/or with individual or multiple features of the exemplary embodiments.

In the figures:

FIG. 1 shows a schematic representation of a first actuation concept according to the invention using a single matrix LED driver, wherein the representation relates to an irradiation area. The irradiation area comprises eight irradiation units. It is indicated by the dots that the switching devices of the first and second type of the matrix LED driver (SW1-SWX and CS1-CSX) are expandable to be able to control more than one irradiation area or more than eight irradiation units per irradiation area by means of the one matrix LED driver.

FIG. 2 shows a schematic representation of an actuation concept according to the invention using a matrix LED driver as shown in FIG. 1, wherein here the actuation of multiple irradiation areas by means of multiple matrix LED drivers is shown, wherein one matrix LED driver is used for the control of two irradiation areas in this embodiment variant. Each irradiation area comprises eight irradiation units. This architecture, as indicated by the dots, is also expandable by additional matrix LED drivers (not shown here), in particular of the same type, and additional irradiation areas (likewise not shown here), in particular of the same type.

FIG. 3 shows a schematic representation of a second actuation concept according to the invention using one LED driver and two multiplexers, wherein the representation relates to an irradiation area. The irradiation area comprises eight irradiation units. It is accordingly indicated by the dots that the switching devices of the second type of the LED driver (CS1-CSX) and the number of the multiplexers are expandable with switching elements of the first type in order to be able to control more than one irradiation area or more than eight irradiation units per irradiation area by means of the actuation concept. Each multiplexer has at least four inputs and one output.

FIG. 4 shows a schematic representation of an actuation concept according to the invention using one LED driver, similarly as shown in FIG. 3, wherein here the actuation of multiple irradiation areas by means of multiple LED drivers and multiple multiplexers is shown, wherein a single LED driver and a single multiplexer are used for the control of two irradiation areas in this embodiment variant. In contrast to the embodiment variant from FIG. 3, each multiplexer therefore has at least eight inputs and one output here. Each irradiation area comprises eight irradiation units. This architecture, as indicated by the dots, is also expandable by additional LED drivers (not shown here), in particular of the same type, and multiplexers, in particular of the same type, and additional irradiation areas (likewise not shown here), in particular of the same type.

FIG. 5 shows a schematic representation of a third actuation concept according to the invention using an LED driver without multiplexer, wherein the representation relates to an irradiation area. The irradiation area comprises eight irradiation units. Accordingly, it is indicated by the dots that the switching devices of the LED driver (CS1-CSX) are expandable to be able to control more than one irradiation area or more than eight irradiation units per irradiation area by means of the one LED driver.

FIG. 6 shows a schematic representation of an actuation concept according to the invention using an LED driver without multiplexer, as shown in FIG. 5, wherein here the actuation of multiple irradiation areas by means of multiple LED drivers without multiplexer is shown, wherein an LED driver is required for the control of an irradiation area in this embodiment variant. Each irradiation area comprises eight irradiation units. This architecture, as indicated by the dots, is also expandable by additional LED drivers (not shown here), in particular of the same type, and additional irradiation areas (likewise not shown here), in particular of the same type.

FIG. 7 shows a schematic representation of a device according to the invention having multiple irradiation areas, which are arranged in rows and columns here. Each irradiation area can therefore be arranged below a cavity of a sample container when the sample container is placed on the sample container receptacle.

### DETAILED DESCRIPTION

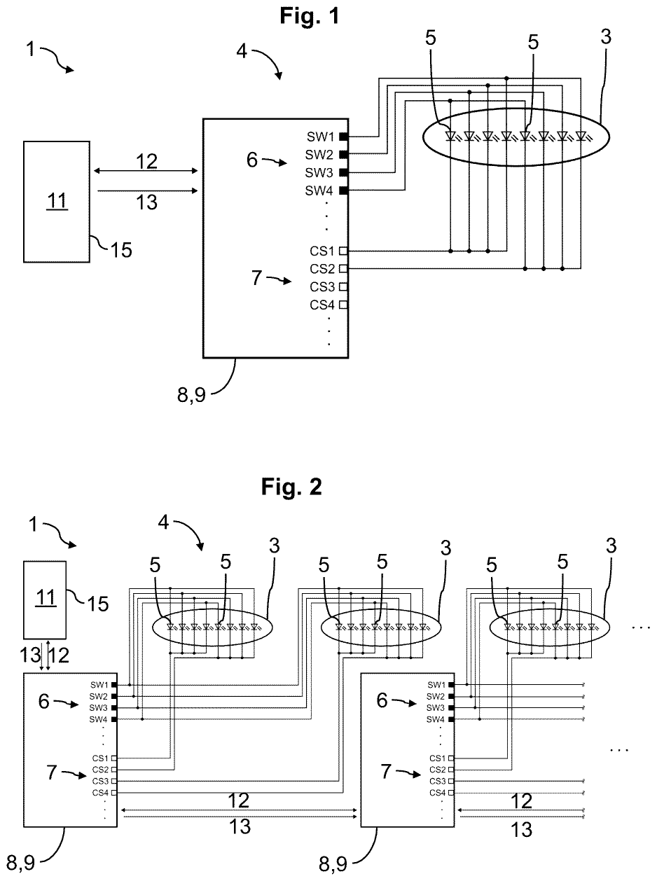

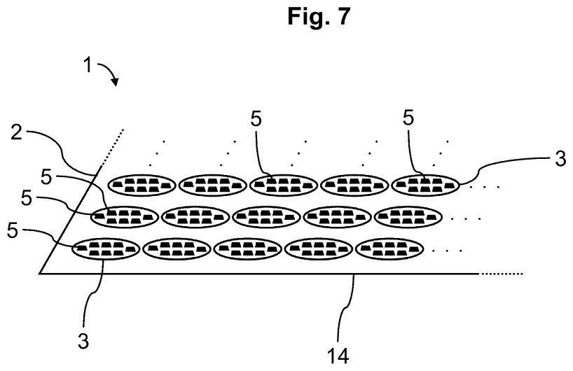

FIGS. 1-7 show multiple embodiment variants of a device 1 according to the invention for irradiating a sample using electromagnetic radiation. Devices 1 of this type are also referred to as illuminators.

The device 1 comprises a sample container receptacle 2 for receiving a sample container having at least two cavities, wherein a separate irradiation area 3 of the device 1 is assigned or assignable to each cavity of the sample container in the state positioned on the device 1. In other words, each irradiation area 3 is always located precisely below one cavity, so that during use of the device 1, preferably exclusively the cavity located above is irradiated by the irradiation area 3 located below.

The devices 1 are adapted here to a sample container designed as a microtitration plate, which includes a plurality of wells as cavities. The number of the irradiation areas 3 corresponds here to the number of wells to be irradiated, so that the device 1 is especially designed for the irradiation of a specific number of wells. Examples of this are: 24-well plate, 96-well plate, 384-well plate, and/or 1536-well plate.

Each irradiation area 3 of the device 1 includes at least four irradiation units 5. Each of the at least four irradiation units 5 emits radiation in a different spectral range. In the embodiment variants shown in FIGS. 1-7, each irradiation area 3 even includes at least eight irradiation units 5, wherein the emittable spectral ranges of the at least eight irradiation units 5 each differ. The irradiation units 5 are designed here as light-emitting diodes.

The device 1 moreover comprises a control electronics unit 4. An irradiation intensity and/or irradiation duration can be controlled thereby for each irradiation unit 5 individually and/or independently of other irradiation units 5. Furthermore, using the control electronics unit 4, an irradiation intensity and/or irradiation duration for each irradiation area 3 can be controlled independently of the other irradiation areas 3.

The control electronics unit 4 can include a memory in which a sequence protocol is storable. The sequence protocol is used to control an irradiation intensity and/or irradiation duration for the irradiation of one or more wells by irradiation areas 3.

In the embodiment variants of FIGS. 1-4, the control electronics unit 4 is designed so that each irradiation unit 5 is controllable or controlled via two switching devices 6, 7, SW1-8 (expandable to SW1-N), CS1-4 (expandable to CS1-N) of the control electronics unit 4, in particular wherein both switching devices 6, 7, SW1-8, CS1-4 have to permit a current flow for an activation of the respective irradiation unit 5.

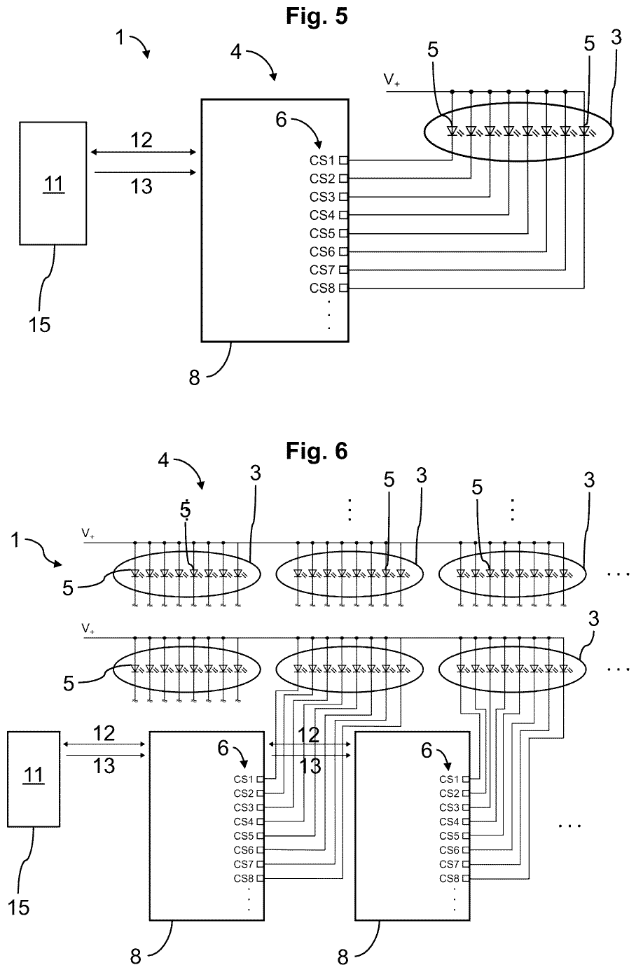

In the embodiment variant of FIGS. 5-6, only switching devices of the second type 7 are provided, so that the wiring expenditure is significantly higher here than in the two embodiment variants from FIGS. 1-4. The embodiment variant of FIGS. 5-6 therefore does not have all advantages which are achievable by the special architecture of the actuation concept of the embodiment variants from FIGS. 1-4. A distinction therefore has to be made between these two hereinafter.

The embodiment variants according to FIGS. 1 and 2 are based on the use of a matrix LED driver 9. A multiplex operation is enabled by the control electronics unit 4, so that multiple switching devices 6, 7, SW1-4, CS1-4 and/or irradiation units 3 are sequentially activatable via this.

The actuation concept of the embodiment variant of FIG. 1 and FIG. 2 provides that a first switching device of the first type 6, which is applied here on the anode side, is designed in each case as a switch SW1-4 (expandable to SW1-N). A second switching device of the second type 7, which is applied here on the cathode side, is designed in each case as a current sink CS1-4 (expandable to CS1-CSN).

For whole numbers, the circuit of the control electronics unit 4 scales according to the pattern: number of irradiation units 5 (LEDs) per irradiation area 3=number of switching devices of the first type 6 (SW)*number of switching devices of the second type 7 (CS).

A switching device of the second type 7 is connected here to twice as many irradiation units 5 as a switching device of the first type 6.

The control electronics unit 4 uses, for the control of each irradiation area 3, six switching devices 6, 7, SW1-4 (expandable to SW1-N), CS1-4 (expandable to CS1-N), wherein four of these are designed as switching devices of the first type 6, SW1-4 and two as switching devices of the second type 7, CS1-4. The control electronics unit 4 is designed so that each switching device of the first type 6, SW1-4 is connected to two irradiation units 5 and each switching device of the second type 7, CS1-4 is connected to four irradiation units 5.

At least two irradiation areas 3 are assigned here to a matrix LED driver 9. Four switching devices of the first type 6, SW1-4, which are designed here as four switches, are connected to a first irradiation area 3 and to a second irradiation area 3. The first irradiation area 3 is connected to two switching devices of the second type 7, CS1-4 and the second irradiation area 3 is connected to two switching devices of the second type 7, CS1-4 separate therefrom. The switching devices of the second type 7, CS1-4 are designed here as current sinks.

The control electronics unit 4 includes half as many matrix LED drivers 9 as the number of the irradiation areas 3 of the device 1. It can preferably be generally provided that one matrix LED driver 9 is used for the control of eight irradiation areas 3. Particularly preferably, it can generally be provided that one matrix LED driver 9 is used for the control of sixteen irradiation areas 3.

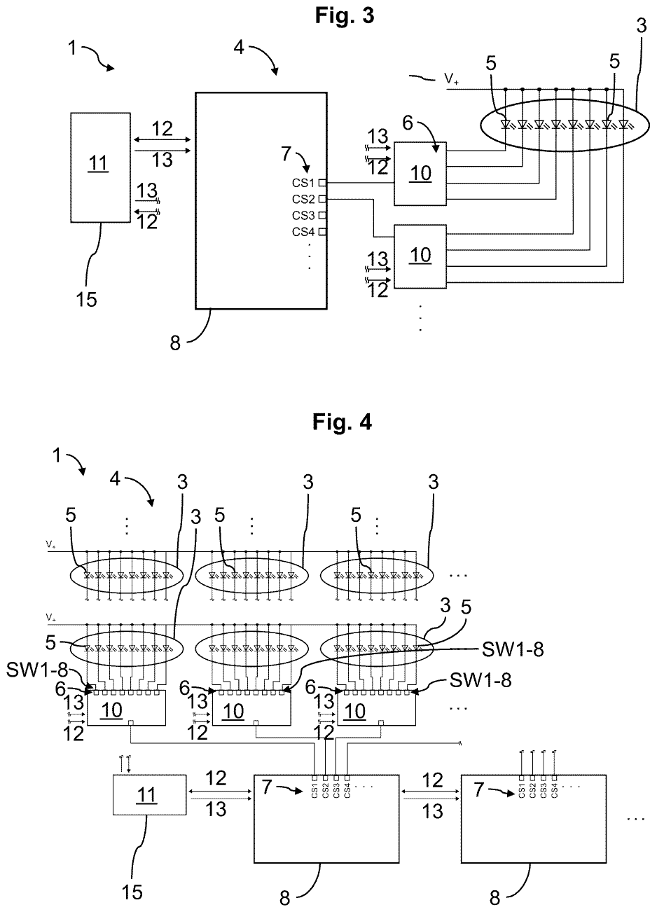

The embodiment variants according to FIGS. 3 and 4 are based on the use of an LED driver 8 in combination with at least one multiplexer 10. Due to the use of at least one multiplexer 10, it is possible that multiple switching devices 6, 7, SW1-8 (expandable to SW1-N), CS1-4 (expandable to CS1-N), and/or irradiation units 3 are sequentially activatable via this. The switching devices of the first and second type 6, 7, SW1-8, CS1-4 can be designed as already described above.

A switching device of the second type 7 is connected here to four times or even eight times as many irradiation units 5 as a switching device of the first type 6. Or in other words: each multiplexer 10 is connected to one switching device of the second type 7 of the LED driver 8. Each multiplexer 10 can include at least four switching devices of the first type 6 (see FIG. 3) or at least eight switching devices of the first type 6 (see FIG. 4).

An irradiation area 3 is connected to at least one multiplexer 10. In FIG. 3, an irradiation area 3 is connected to two multiplexer 10. A first multiplexer 10 of the two is connected here to a first switching device of the second type 7, CS1-4 (expandable to CS1-N) of the LED driver 8 and a second multiplexer 10 of the two is connected to a second switching device of the second type 7, CS1-4 of an LED driver 8.

The embodiment variants according to FIGS. 5 and 6 are based on the use of an LED driver 8 without multiplexer 10. The number of switching devices per LED driver for controlling the irradiation units 5 of an irradiation area 3 is accordingly greater than in the embodiment variant with multiplexer 10.

The control electronics unit 4 of the device 1 comprises at least one microcontroller 11, by means of which the switching devices 6, 7, SW1-8, CS1-8 are controllable. The microcontroller 11 is connected for this purpose via at least one data line 12 and at least one clock line 13 to the at least one matrix LED driver 9 or, in the case of the other embodiment variants, to the at least one LED driver 8.

The control electronics unit 4 includes multiple LED drivers 8, 9, which are controllable via a single microcontroller 11, wherein at least one data line 12 and/or at least one clock line 13 is formed between the microcontroller 11 and a first LED driver 8, 9, wherein at least one further data line 12 and/or at least one further clock line 13 is formed between the first LED driver 8, 9 and a next LED driver 8, 9. In a continuation, at least one data line and/or at least one clock line is formed in each case between adjacent LED drivers.

The at least one data line 12 can be a serial data line. The at least one clock line 13 can be a serial clock line.

The control electronics unit 4 and the irradiation areas 3 can be formed on a common printed circuit board 14. In the embodiment variants shown, the control electronics unit 4 and the irradiation areas 3 are formed, with the exception of the microcontroller 11, on a common printed circuit board 14, wherein the microcontroller 11 is formed on a microcontroller printed circuit board 15 independent thereof.

In the embodiment variants from FIGS. 3 and 4, the microcontroller 11 of the control electronics unit 4 is connected via at least one data line 12 and/or at least one clock line 13 to the at least one multiplexer 10.

The invention thus relates in particular to a device 1 for irradiating a sample using optical radiation, the device 1 comprising a sample container receptacle 2 for a sample container having at least two cavities, wherein a separate irradiation area 3 of the device 1 is assigned or assignable to each cavity of a sample container in the state positioned on the device 1, so that the device 1 includes as many separate irradiation areas 3 as a sample container has cavities, and a control electronics unit 4, characterized in that the irradiation areas 3 each comprise at least four irradiation units 5, wherein the emittable spectral ranges of the at least four irradiation units 5 differ from one another.

### LIST OF REFERENCE SIGNS

1 device for irradiating a sample
2 sample container receptacle
3 irradiation area
4 control electronics unit
5 irradiation unit
6 switching device of the first type
7 switching device of the second type
8 LED driver
9 matrix LED driver
10 multiplexer
11 microcontroller
12 data line
13 clock line
14 printed circuit board
15 microcontroller printed circuit board
SW1-8 switch
CS1-8 current sink

1. A device (1) for irradiating a sample using electromagnetic radiation, the device (1) comprising:
a sample container receptacle for a sample container having at least two cavities, wherein a separate irradiation area (3) of the device (1) is assigned or assignable to each cavity of the sample container in a state positioned on the device (1) to provide at least two separate irradiation areas (3); and
a control electronics unit (4);
wherein the irradiation areas (3) each comprise at least four irradiation units (5), and emittable spectral ranges of the at least four irradiation units (5) differ.

2. The device (1) as claimed in claim 1, wherein the control electronics unit (4) is configured to control an irradiation intensity and/or irradiation duration individually for each said irradiation unit (5).

3. The device (1) as claimed in claim 1, wherein the control electronics unit (4) is configured to control an irradiation intensity and/or irradiation duration for each said irradiation area (3) independently of at least one further one of the irradiation areas (3).

4. The device (1) as claimed in claim 1 claims, wherein the control electronics unit (4) is configured to execute a sequence protocol for controlling an irradiation intensity and/or irradiation duration for irradiating a sample by means of the irradiation area (3).

5. The device (1) as claimed in claim 1, wherein the control electronics unit (4) is configured such that each of the irradiation units (5) is controllable or controlled via two switching devices (6, 7, SW1-8, CS1-8) of the control electronics unit (4), and both of the switching devices (6, 7, SW1-8, CS1-8) have to permit a current flow for an activation of the respective irradiation unit (5).

6. The device (1) as claimed in claim 5, wherein a first of the switching devices is of a first type (6) and is designed as a switch (SW1-8) and/or a second one of the switching devices is of a second type (7) and is designed as a current sink (CS1-8).

7. The device (1) as claimed in claim 1, wherein each irradiation unit (5) comprises at least one light-emitting diode.

8. The device (1) as claimed in claim 1, wherein the control electronics unit (4) comprises an LED driver (8, 9).

9. The device (1) as claimed in claim 1, wherein the control electronics unit (4) comprises at least one multiplexer (10) and/or enables multiplex operation, so that multiple switching devices (6, 7, SW1-8, CS1-8) and/or the irradiation units (3) are sequentially activatable.

10. The device (1) as claimed in claim 1, wherein the control electronics unit (4) is configured and/or set so that at most two of the irradiation units (5) are activatable at a same time in one said irradiation area (3).

11. The device (1) as claimed in claim 1, wherein the irradiation areas (3) each comprise at least six irradiation units (5), wherein radiation is emittable in a different spectral range by each of the irradiation units (5).

12. The device (1) as claimed in claim 1, wherein the sample container receptacle (2) is designed to receive a microtitration plate, one said irradiation area (3) separate from other ones of the irradiation areas (3) is assigned to each well in a state of the microtitration plate positioned on the device (1).

13. The device (1) as claimed in claim 1, wherein a switching device of a second type (7) designed as a current sink (CS1-8) is connected to twice as many of the irradiation units (5) as a switching device of a first type (6) designed as a switch (SW1-8) and/or wherein a circuit of the control electronics unit (4) is constructed as follows: a number of the irradiation units (5) per each said irradiation area (3)=a number of the switching devices of the first type (6) times a number of the switching devices of the second type (7).

14. The device (1) as claimed in claim 13, wherein the control electronics unit (4) has six of the switching devices (6, 7, SW1-8, CS1-8) for the control of each said irradiation area (3), and four of the switching devices are switching devices of the first type (6, SW1-8) and two of the switching devices are switching devices of the second type (7, CS1-8).

15. The device (1) as claimed in claim 13, wherein the control electronics unit (4) is configured such that each said switching device of the first type (6, SW1-8) is connected to two of the irradiation units (5) and each said switching device of the second type (7, CS1-8) is connected to four of the irradiation units (5).

16. The device (1) as claimed in claim 1, wherein the irradiation units (5) of one said irradiation area (3) are arranged so that at least two of the irradiation units (5) always have an identical orientation.

17. The device (1) as claimed in claim 13, wherein the control electronics unit (4) comprises at least one microcontroller (11), by which the switching devices (6, 7, SW1-8, CS1-8) are controllable, and the microcontroller (11) is connected via at least one data line (12) and/or at least one clock line (13) to at least one LED driver (8, 9).

18. The device (1) as claimed in claim 1, wherein at least two of the irradiation areas (3) are assigned to an LED driver (8, 9).

19. The device (1) as claimed in claim 1, wherein the control electronics unit (4) comprises at least four LED drivers (8, 9) which are controllable via a single microcontroller (11), and at least one data line (12) and/or at least one clock line (13) is formed between the microcontroller (11) and a first of the LED drivers (8, 9), wherein a further data line (12) and/or a further clock line (13) is formed between the first LED driver (8, 9) and a next said LED driver (8, 9).

20. The device (1) as claimed in claim 1, wherein the control electronics unit (4) and the irradiation areas (3) are formed on a common printed circuit board (14), and the microcontroller (11) is formed on a microcontroller printed circuit board (15) independent thereof.

21. The device (1) as claimed in claim 1, wherein one said irradiation area (3) is connected to at least one multiplexer (10).

22. The device (1) as claimed in claim 1, wherein one said irradiation area (3) is connected to at least two multiplexers (10), and a first multiplexer (10) of the at least two multiplexers is connected to a first switching device of a second type (7, CS1-8) designed as a current sink (CS1-8) of an LED driver (8, 9) and a second multiplexer (10) of the at least two multiplexers is connected to a second switching device of the second type (7, CS1-8) of an LED driver (8, 9).

23. The device (1) as claimed in claim 21, wherein a microcontroller (11) of the control electronics unit (4) is connected via at least one data line (12) and/or at least one clock line (13) to the at least one multiplexer (10).
